(19) United States
(12) Patent Application Publication
(10) Pub. No.: US 2005/0011930 A1
(43) Pub. Date: Jan. 20, 2005

(54) Movable core with valve shaft of solenoid valve and method of manufacturing the same

(76) Inventor: Akira Hayashi, Nissin (JP)

Correspondence Address: BURNS DOANE SWECKER & MATHIS L L P, POST OFFICE BOX 1404, ALEXANDRIA, VA, 22313-1404, US

(21) Appl. No.: 10/892,233

(22) Filed: Jul. 16, 2004

(30) Foreign Application Priority Data
Jul. 17, 2003 (JP) 2003-276219

(51) Int. Cl. B23K 1/00

(52) U.S. Cl. 228/101

(57) ABSTRACT

A method of manufacturing a movable core having a valve shaft, of a solenoid valve with which the movable core and the valve shaft can be easily and accurately aligned with each other. The valve shaft and the movable core are manufactured by sintering as follows. First, with a lower punch inserted in a cavity of a first mold, SUS powder having an average particle diameter of 150 micrometer is put in the cavity. The powder is compacted into a powder compact in the shape of a valve shaft by lowering an upper punch into the cavity. The first mold is slightly lowered so that the powder compact slightly protrudes from the cavity. Fe powder having an average particle diameter of 150 micrometers is put in a cavity of a second mold so as to be deposited on the powder compact in the cavity of the first mold. The upper punch is lowered to compact the powder in the second mold into a powder compact in the shape of the core. After releasing the powder compacts, they are joined together by sintering.

### BACKGROUND OF THE INVENTION

This invention relates to a movable core carrying a valve shaft, of a solenoid valve for use in an actuator for controlling vehicle brake hydraulic pressure, and a method of manufacturing the same.

FIG. 2 shows a typical actuator for controlling vehicle brake hydraulic pressure, which comprises a hydraulic pressure control unit 1, a motor unit 2 coupled to one side of the control unit 1, and an electronic control unit (ECU) 3 coupled to the opposite side of the control unit 1. This type of actuator is disclosed in JP patent publication 2001-260846.

The control unit 1 includes a housing 10, typically made of an aluminum alloy, in which are mounted a reservoir 12, a pump 13 and a pair of pressure control valves 30 and 20 for increasing and reducing pressure, respectively. The housing 10 is formed with a first passage 16 extending from a master cylinder port 14 to the pressure increase valve 30 and then to a wheel cylinder port 15, a second passage 17 extending from the wheel cylinder port 15 to the reservoir 12 through the pressure reduction valve 20, and a third passage 18 extending from the reservoir 12 through the pump 13 and the pressure increase valve 30 to the wheel cylinder port 15.

The control valves 20 and 30 are typically solenoid valves. For example, in JP patent publication 4-287840, a solenoid valve similar to the one shown in FIG. 1 is used as the pressure increase valve 30. It is to be understood that FIG. 1 itself shows one embodiment of the present invention. This valve comprises a tubular yoke 31, a tubular bobbin 32 mounted in the yoke 31, a current-excited coil 33 wound on the bobbin 32, a movable core (plunger) 34 axially movably inserted in a guide member 37 fitted in the bobbin 32, and a valve shaft 35 fixed to the core 34 and having at its front end a valve body 38 adapted to contact a valve seat 39. By selectively activating and deactivating the coil, the valve shaft 35 is moved axially together with the core 34 so that its valve body 38 is brought into and out of contact with the valve seat 39.

In order to move the core 34 in its axial direction under the magnetic force produced by the coil 33, the core 34 has to be formed of a magnetizable material. On the other hand, the valve shaft 35 is desirably not influenced by the magnetic force from the coil. It is thus formed of a non-magnetizable material. In other words, the core 34 and the valve shaft 35 are formed of different materials. Conventional such cores and valve shafts were therefore manufactured separately and joined together.

JP patent publication 2000-087117 proposes to compact ferromagnetic powder or a mixture of such ferromagnetic powder and other powders into the shape of the core 34, fitting this compacted green article onto the valve shaft 35 and sintering it. By sintering, the core is joined to the valve shaft 35. That is, when the core is formed, it is simultaneously joined to the valve shaft.

But with this arrangement too, the valve shaft 35 still has to be separately formed by e.g. cutting. Moreover, the step of fitting the compacted green article onto the valve shaft 35 makes it more troublesome to manufacture and assemble the core and the valve shaft. Furthermore, it is difficult to fit the core onto the valve shaft such that they are accurately aligned with each other. If they are even slightly misaligned with each other, the valve body 38 may not be properly seated on the valve seat 39, thus making it difficult to reliably open and close the valve. It will be particularly difficult to completely seal the valve when so desired.

An object of this invention is to provide a method of manufacturing a movable core having a valve shaft, of a solenoid valve with which the movable core and the valve shaft can be easily and accurately aligned with each other.

### SUMMARY OF THE INVENTION

To accomplish this object, the movable core and the valve shaft are formed by simultaneous sintering.

Specifically, the present invention provides the following two methods:

1) A method of manufacturing a movable core member for use in a solenoid valve, said movable core member comprising a core and a valve shaft, said solenoid valve being adapted to be opened and closed by moving said valve shaft together with said core, said method comprising the steps of preparing a mold; putting a first powder selected from a non-magnetizable powder and a mixture of a non-magnetizable powder and another powder into said mold; compacting said first powder to form a first powder compact in the shape of said valve shaft; putting a second powder selected from a magnetizable powder and a mixture of a magnetizable powder and another powder into said mold so as to be deposited on said first powder compact; compacting said second powder to form a second powder compact in the shape of said core; and sintering said first and second powder compacts to join said first and second powder compacts together, thereby forming said valve shaft from said first powder compact and said core from said second powder compact as a one-piece article.

2) A method of manufacturing the movable core member as described above, said method comprising the steps of preparing a mold; putting a first powder selected from a magnetizable powder and a mixture of a magnetizable powder and another powder into said mold; compacting said first powder to form a first powder compact in the shape of said core; putting a second powder selected from a non-magnetizable powder and a mixture of a non-magnetizable powder and another powder into said mold so as to be deposited on said first powder compact; compacting said second powder to form a second powder compact in the shape of said valve shaft; and sintering said first and second powder compacts to join said first and second powder compacts together, thereby forming said valve shaft from said second powder compact and said core from said first powder compact as a one-piece article.

With either of the above methods, the core and the valve shaft are rigidly joined together as a practical one-piece article. The core and the valve shaft can be formed exactly following the contour of the mold cavity with their axes accurately aligned with each other.

The magnetizable powder may be Fe—P powder, Fe—Si powder, Fe—Si—P powder, permalloy powder, permendur alloy powder, or an electromagnetic stainless powder such as SUS 401. The non-magnetizable powder may be a non-magnetizable stainless steel such as SUS 304.

### BRIEF DESCRIPTION OF THE DRAWINGS

Other features and objects of the present invention will become apparent from the following description with reference to the accompanying drawings, in which:

FIG. 1 is a sectional side view of a movable core member embodying the present invention as used in a solenoid valve;

FIG. 2 is a schematic side view of a hydraulic pressure controlling actuator including solenoid valves each having the movable core member shown in FIG. 1;

FIGS. 3A-3D show a first method for manufacturing the movable core member according to the present invention;

FIGS. 4A-4D show a second method for manufacturing the movable core member according to the present invention;

FIG. 5 shows a third method for manufacturing the movable core member according to the present invention; and

FIG. 6 shows a different movable core member embodying the present invention.

### DETAILED DESCRIPTION OF THE PREFERRED EMBODIMENT

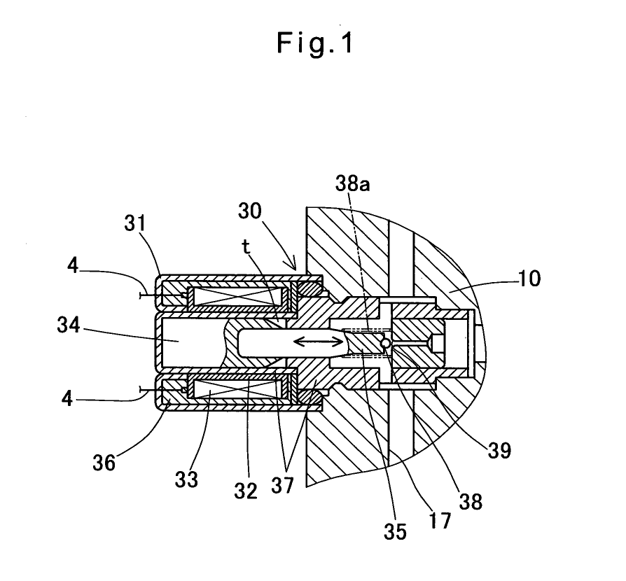

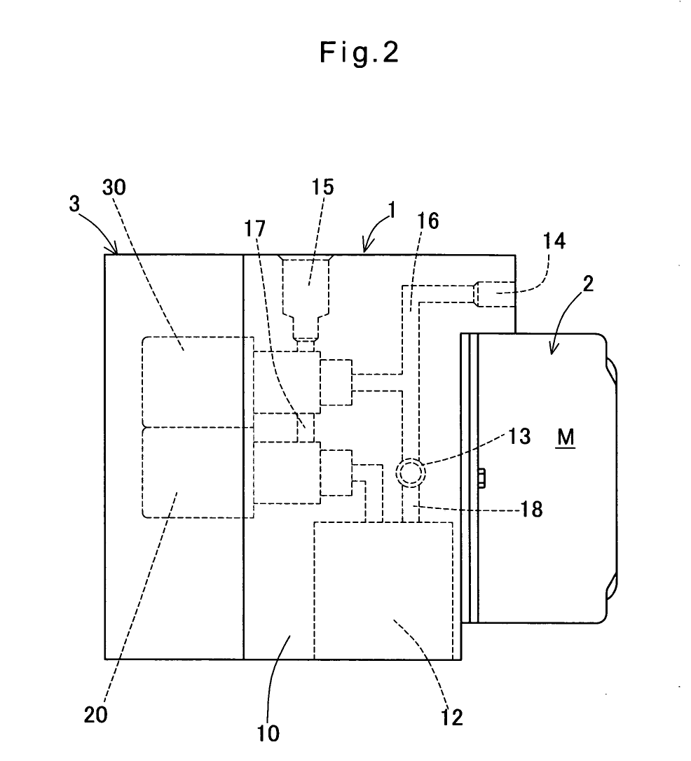

FIG. 1 shows the pressure increase control valve 30 embodying the present invention, which is mounted in the hydraulic pressure control unit 1 shown in FIG. 2 instead of the conventional pressure increase valve 30. This particular control unit 1 is mounted in an actuator of an antilock brake system (ABS) for controlling the vehicle brake hydraulic pressure in a known manner. The pressure increase control valve 30 is liquid-tightly mounted to the housing 10 of the control unit 1 by means of a metal seal that is fitted in the housing 10 so as to extend across the passage 17, which extends from the wheel cylinder port 15. The pump 13 is driven by a motor M.

The tubular yoke 31 of the pressure increase control valve 30 has its inner end open. The tubular bobbin 32 is coaxial with the yoke 31. The coil 33 is wound around the bobbin 32, as described above. The space between the coil 33 and the yoke 31 is filled with an epoxy resin 36. The core (plunger) 34 carrying the valve shaft 35 is received in the bobbin 32 so as to be movable in its axial direction, as described earlier. Its axial stroke is limited to t which is the gap between the guide 37 and the end of the core 34. By selectively activating and deactivating the coil, the valve body 38 at the tip of the valve shaft 35 is adapted to be moved into and out of contact with the valve seat 39. The valve thus selectively opens and closes. Electric power is supplied to the coil through terminals 4. When the coil is deactivated, the valve shaft 35 is pushed by a return spring 38a until the valve body 38 separates from the valve seat 39.

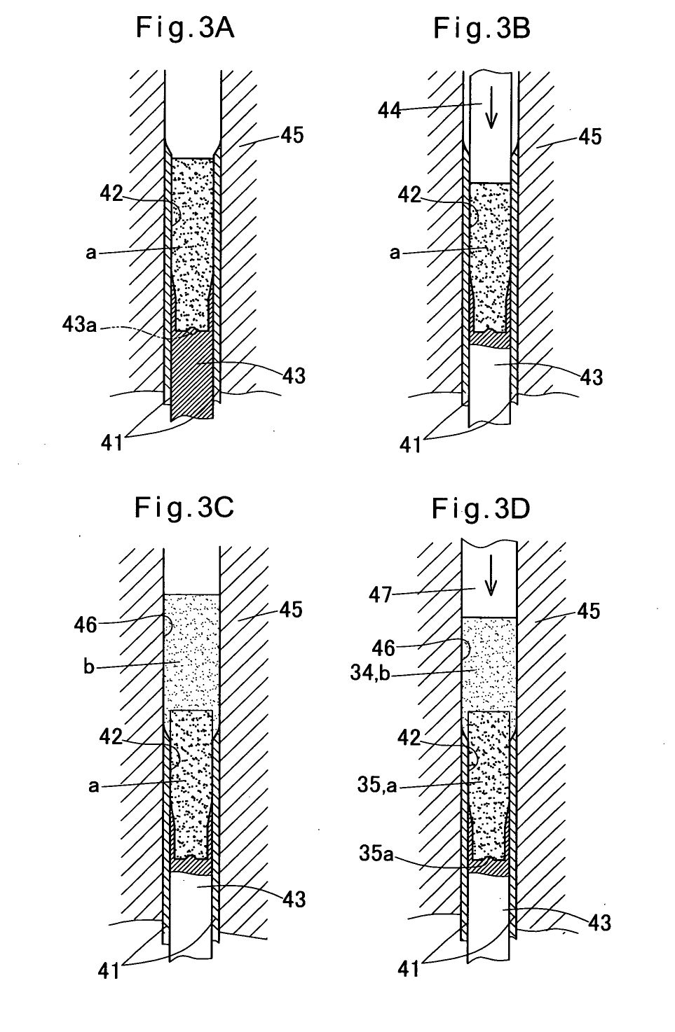

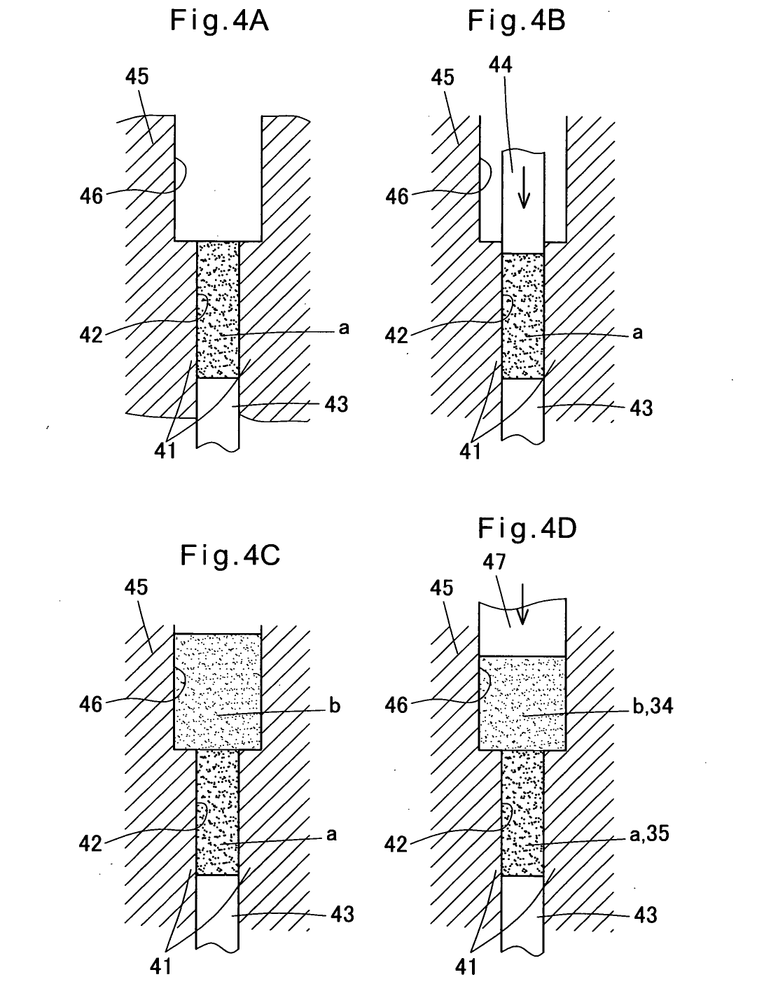

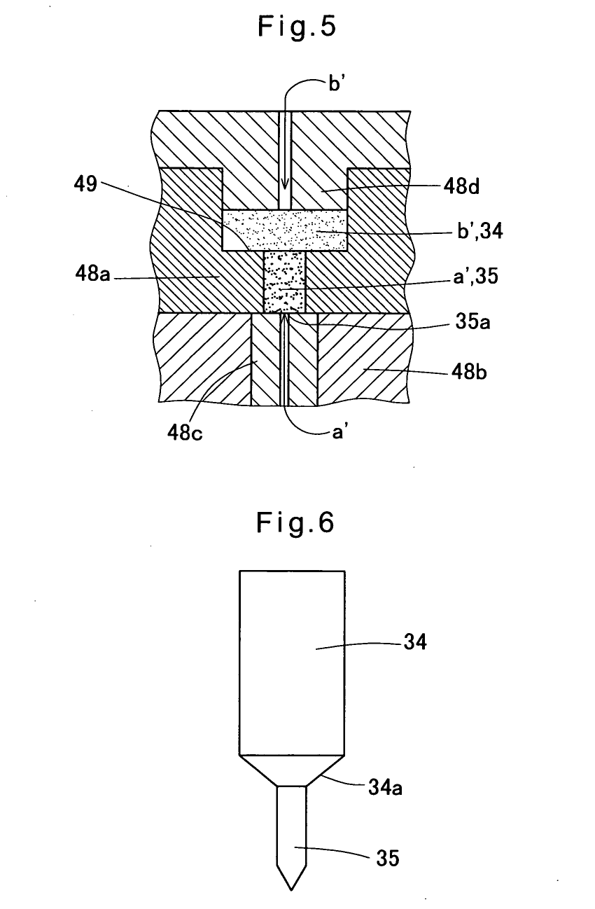

The valve shaft 35 and the movable core 34 of the solenoid valve 30 according to the invention are formed by sintering, using one of the three methods shown in FIGS. 3A-D, FIGS. 4A-D and FIG. 5, respectively.

The method of FIGS. 3A-3D comprises the following steps:
1) inserting a die or mold 41 for forming the valve shaft 35 into a die or mold 45 for forming the core 34;
2) inserting a lower punch 43 into a cavity 42 of the die 41 from below the die;
3) putting a non-magnetizable powder, typically SUS powder a having an average particle diameter of 150 micrometers into the cavity 42 (FIG. 3A);
4) lowering an upper punch 44 into the cavity 42 to compact the powder a into the shape of the valve shaft 35 (FIG. 3B);
5) raising the upper punch 44 and then raising the lower punch 43 or lowering the die 41 until the compact a slightly protrudes from the top of the die 41;
6) putting a magnetizable powder, typically Fe powder b having an average particle diameter of 150 micrometers into a cavity 46 of the core-forming die 45 (FIG. 3C);
7) lowering the upper punch 47 into the cavity 46 to compact the powder b into the shape of the core 34 (FIG. 3D);
8) releasing the compacts a and b from the die; and
9) sintering the compacts a and b at 1150° C. for 30 minutes to form a one-piece core member comprising the core 34 and the valve shaft 35.

The valve shaft 35 of this core member penetrates into the core 34. In contrast, the method shown in FIGS. 4A-4D forms a core member comprising a core 34 and a valve shaft 35 which does not penetrate into the core 34. In this method, a one-piece die comprising the core-forming die 41 and the valve shaft-forming die 45 is used. In this method, after compacting the powder a, the lower punch 43 is raised or the die (41, 45) is lowered until the top of the powder a is substantially flush with the shoulder between the dies 41 and 45. Thus, when the powder b is compacted subsequently, the compacts a and b are temporarily joined together along a horizontal plane as shown in FIG. 4D. The thus joined compacts a and b are released from the die (41, 45) and rigidly joined together by sintering. In an alternative method of FIGS. 4A-4D, the die (41, 45) is positioned upside down, and the powder b is first put in the cavity of the die 45 and compacted, and then the powder a is put in the cavity of the die 41 and compacted.

In the method of FIG. 5, a mold assembly 48 comprising molds 48a, 48b, 48c and 48d is used. A mixture a′ comprising 50 wt % of SUS powder having an average particle size of 150 micrometers and 50 wt % of a resin is injection-molded into a cavity 49 of the mold 48a from below the mold 48a, and a mixture b′ comprising 50 wt % of Fe powder having an average particle size of 150 micrometers and 50 wt % of a resin is injection-molded into a cavity 49 from above the mold 48a. After metal injection molding, the resin is partially vaporized until its weight is 10-50% of the original weight, and the compacts a′ and b′ are released from the mold 48a and then sintered at 1150 degrees Celsius for 30 minutes. By sintering, the resin completely vaporizes.

A steel ball as the valve body 38 is pressed into a recess 35a formed in the tip of the valve shaft 35 (FIG. 3D). If the steel ball cannot be sufficiently rigidly fixed to the valve shaft 35 by press-fitting, any other joint means may be used such as bonding for more rigid joining. Also, in order to more rigidly fix the steel ball to the valve shaft, the powder a or a′ may be compacted with the steel ball placed on the lower punch 43 or the mold 48c to temporarily join the steel ball to the compact a or a′. Then, when the compact a or a′ is sintered, the steel ball is rigidly joined to the valve shaft. Also, the steel ball may be formed as an integral part of the valve shaft by putting powder in a recess 43a (FIG. 3A) formed in the top surface of the lower punch 43 or the mold 48c, and compacting and sintering the powder together with the powder a or a′. The valve body of a needle valve shaft as shown in FIG. 6 is actually a pointed tip of the valve shaft. Such a valve body is formed when the powder a or a′ is compacted and sintered.

The core 34 and the valve shaft 35 of the present invention, which are formed by simultaneous sintering, are rigidly joined together. Since the core and the valve shaft are shaped exactly following the shape of the cavity of the mold, they can be formed so as to be accurately aligned with each other. The valve can thus be accurately opened and closed. Particularly with the needle valve shaft shown in FIG. 6, the taper angle of the tapered surface of the pointed tip, which serves as the valve body 38, can be determined with high accuracy. The degree of opening of the valve can thus be controlled with high accuracy.

While the core of the embodiment has been described as being a part of a pressure increase valve (such as the valve 30) to be mounted in a hydraulic pressure control unit (such as the control unit 1), it can also be used as a part of the pressure reduction valve 20 or any other solenoid valve to be mounted not only in a vehicle brake hydraulic pressure controlling actuator but in any other device.

Since the movable core and the valve shaft are formed as an integral, one-piece member by sintering powders, both the core and the valve shaft can be formed with high dimensional accuracy with their axes accurately aligned with each other. Also, they can be formed easily at a low cost. The valve containing this movable core can be opened and closed with high accuracy.

1. A method of manufacturing a movable core member for use in a solenoid valve, said movable core member comprising a core and a valve shaft, said solenoid valve being structured to be opened and closed by moving said valve shaft together with said core, said method comprising:
preparing a mold;
putting a first powder selected from a non-magnetizable powder and a mixture of a non-magnetizable powder and another powder into said mold;
compacting said first powder to form a first powder compact in the shape of said valve shaft;
putting a second powder selected from a magnetizable powder and a mixture of a magnetizable powder and another powder into said mold so as to be deposited on said first powder compact;
compacting said second powder to form a second powder compact in the shape of said core; and
sintering said first and second powder compacts to join said first and second powder compacts together, thereby forming said valve shaft from said first powder compact and said core from said second powder compact as a one-piece article.

2. The movable core member manufactured by the method of claim 1.

3. A method of manufacturing a movable core member for use in a solenoid valve, said movable core member comprising a core and a valve shaft, said solenoid valve being structured to be opened and closed by moving said valve shaft together with said core, said method comprising:
preparing a mold;
putting a first powder selected from a magnetizable powder and a mixture of a magnetizable powder and another powder into said mold;
compacting said first powder to form a first powder compact in the shape of said core;
putting a second powder selected from a non-magnetizable powder and a mixture of a non-magnetizable powder and another powder into said mold so as to be deposited on said first powder compact;
compacting said second powder to form a second powder compact in the shape of said valve shaft; and
sintering said first and second powder compacts to join said first and second powder compacts together, thereby forming said valve shaft from said second powder compact and said core from said first powder compact as a one-piece article.

4. The movable core member manufactured by the method of claim 3.
